(19) United States
(12) Patent Application Publication
(10) Pub. No.: US 2005/0055269 A1
(43) Pub. Date: Mar. 10, 2005

(54) Systems and methods for determining user actions

(76) Inventors: Alex Roetter, Palo Alto, CA (US); Deepak Jindal, Mountain View, CA (US)

Correspondence Address: HARRITY & SNYDER, LLP, 11240 WAPLES MILL ROAD, SUITE 300, FAIRFAX, VA, 22030, US

(21) Appl. No.: 10/653,899

(22) Filed: Sep. 4, 2003

(51) Int. Cl. G06F 17/60

(52) U.S. Cl. 705/14

(57) ABSTRACT

A system tracks user actions associated with a displayed advertisement. The system may generate a cookie in response to a user action, such as an ad click, and transmit the cookie to the user. The cookie may be associated with a particular advertiser. The system may then determine whether other actions performed by the user resulted from the advertisement.

### FIELD OF THE INVENTION

The present invention relates generally to computer searching and, more particularly, to tracking conversions associated with determining user actions.

### BACKGROUND OF THE INVENTION

Networks, such as the Internet, have become an increasingly important part of our everyday lives. Millions of people now access the Internet on a daily basis to shop for goods and services and obtain information of interest.

For example, suppose an individual wishes to purchase a printer via the Internet. The individual accesses the Internet and types in a vendor's uniform resource locator (URL). The individual may then access that vendor's home page to determine whether the vendor has the product that this individual wishes to purchase.

If the individual does not know which vendors sell printers, the individual may access a web site associated with a search engine. The individual enters the generic term “printer” into the search engine to attempt to locate a vendor that sells printers. Using a search engine in this manner to locate individual web sites that offer the desired product or service often results in a list of hundreds or even thousands of “hits,” where each hit may correspond to a web page that relates to the search term.

In addition, the search engine may provide companies' advertisements relating to the product or service to which the individual is interested. For the example above, the search engine may provide advertisements for printers. The search engine may charge companies a predetermined fee each time the companies' advertisements are displayed to a user of the search engine. A more recent trend is to charge companies a fee each time their advertisement is selected by a user (i.e., each time a user clicks on the displayed advertisement).

Advertisers, however, are aware that not all clicks on their advertisements result in desired user actions or “conversions.” A conversion may be defined by the advertiser and may represent a purchase, a registration, a page-view, etc. Advertisers, therefore, like to know the conversion rate associated with their advertisements being displayed to users. This allows the advertiser to maximize their return on investment (ROI) by reducing fees paid on non-profitable advertisements.

Conversion tracking may also be useful for search engine companies. If a search company was able to accurately track conversions, the search engine company may be able to vary the way in which companies are charged for targeted ads.

Therefore, there exists a need for systems and methods for tracking conversions associated with user actions.

### SUMMARY OF THE INVENTION

Implementations consistent with the principles of the invention detect whether particular user actions are performed.

In accordance with one implementation consistent with the principles of the invention, a method for tracking user actions is provided. The method may include identifying a user action and generating a cookie in response to the user action, where the cookie is associated with the advertiser. The method may also include transmitting the cookie to the user and receiving the cookie from the user in response to an other action by the user.

In another implementation consistent with the principles of the invention, a server includes a memory and a processor. The processor may be configured to receive at least one cookie in response to a user action, where the cookie is associated with an advertiser. The processor may also be configured to store the at least one cookie in the memory and receive a conversion indication associated with the advertiser. The processor may further be configured to determine whether the conversion resulted from an advertisement associated with the advertiser based at least in part on the stored cookie.

In a further implementation consistent with the principles of the invention, a method for enabling tracking of users' actions is provided. The method may include providing a conversion tracking option to an advertiser and receiving a selection from the advertiser. The selection may indicate that the advertiser wishes to enable tracking of users' actions for at least one account associated with the advertiser. The method may further include enabling tracking for the at least one account.

In still another implementation consistent with the principles of the invention, a method for tracking user actions is provided. The method may include providing an ad to a user. The method may also include receiving an ad click associated with the ad, generating a cookie in response to the ad click and transmitting the cookie to the user. The method may further include receiving information in response to a user action, where the information indicates that the user performed a conversion associated with an advertiser, and determining whether the conversion resulted from the ad.

In another implementation consistent with the principles of the invention, a method that may include selecting an ad associated with an advertiser and receiving a cookie in response to the selection is provided. The method may also include performing a conversion associated with the advertiser and determining whether an identifier associated with the cookie matches an identifier on a web page associated with the conversion. The method may further include transmitting the cookie when the identifiers match.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is an exemplary diagram of a network in which systems and methods consistent with the principles of the invention may be implemented;

FIG. 2 is an exemplary diagram of a server in the network of FIG. 1 in an implementation consistent with the principles of the invention;

FIG. 3 is a functional block diagram of the conversion tracker of FIG. 1 in an implementation consistent with the principles of the invention;

FIG. 4 is an exemplary flow diagram illustrating processing associated with enabling conversion tracking in an implementation consistent with the principles of the invention; and

FIG. 5 is an exemplary flow diagram illustrating processing associated with conversion tracking in an implementation consistent with the principles of the invention.

### DETAILED DESCRIPTION

The following detailed description of implementations consistent with the present invention refers to the accompanying drawings. The same reference numbers in different drawings may identify the same or similar elements. Also, the following detailed description does not limit the invention.

Systems and methods consistent with the principles of the invention perform conversion tracking associated with advertisers. A conversion ratio may then be determined based on, for example, the number of conversions and the number of times an ad is selected or displayed.

### Exemplary Network

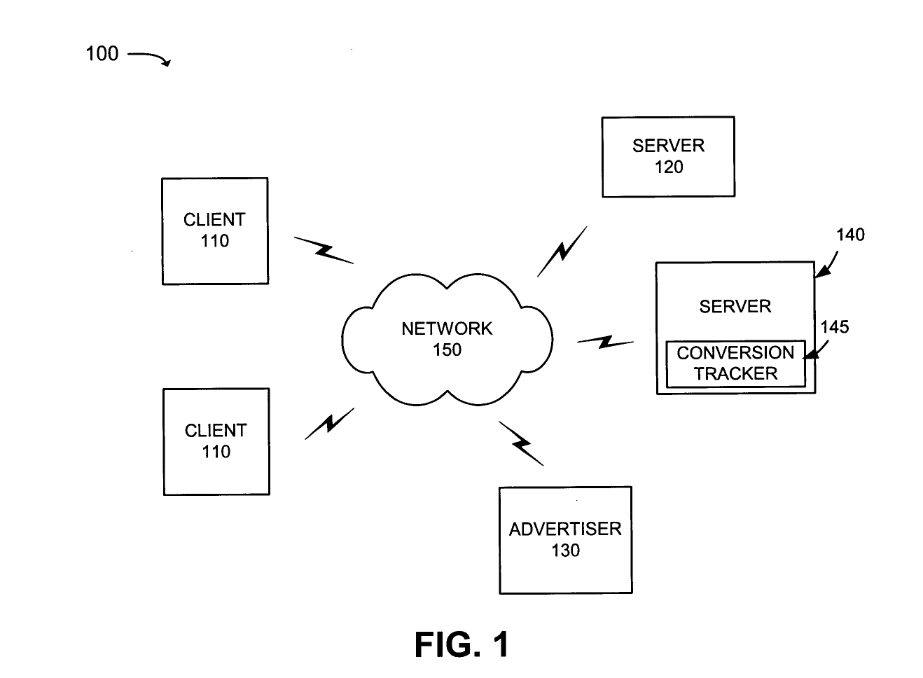

FIG. 1 is an exemplary diagram of a network 100 in which systems and methods consistent with the principles of the invention may be implemented. Network 100 may include clients 110, servers 120 and 140 and advertiser 130 connected via network 150. Clients 110, server 120, advertiser 130 and server 140 may connect to network 150 via wired, wireless, or optical connections. Network 150 may include a local area network (LAN), a wide area network (WAN), a telephone network, such as the Public Switched Telephone Network (PSTN), an intranet, the Internet, a different type of network, or a combination of networks. Two clients 110, one server 120, one advertiser 130 and one server 140 have been illustrated as connected to network 150 in FIG. 1 for simplicity. In practice, there may be more or fewer clients, servers and advertisers. Also, in some instances, a client may perform the functions of a server and a server may perform the functions of a client. Additionally, in alternative implementations, the functions performed by one server may be combined with the functions performed by another server. For example, server 120 may perform the functions of both servers 120 and 140, or vice versa.

Clients 110 may include devices, such as personal computers, lap top computers, personal digital assistants (PDAs), wireless telephones, etc., threads or processes running on these devices, and/or objects executable by these devices. Server 120 may include one or more server devices, computer processors, threads, and/or objects that operate upon, search, maintain, and/or manage documents in a manner consistent with the principles of the invention.

Advertiser 130 may include one or more server devices/platforms that provide information, products and/or services to clients 110. For example, advertiser 130 may represent a vendor that sells goods/services over the Internet. Advertiser 130 may also pay for advertising associated with searches performed by server 120. For example, advertiser 130 may pay for advertising associated with one or more keywords. When server 120 receives a search query with the keyword(s), information associated with advertiser 130 may be displayed to the user with the search results.

Server 140, consistent with the present invention, may include one or more server devices, computer processors, threads, and/or objects that track conversion information associated with clients 110 and advertiser 130. In an exemplary implementation consistent with principles of the invention, server 140 may include a conversion tracker 145 that tracks conversions associated with clients 110 accessing information from advertiser 130.

### Exemplary Server Architecture

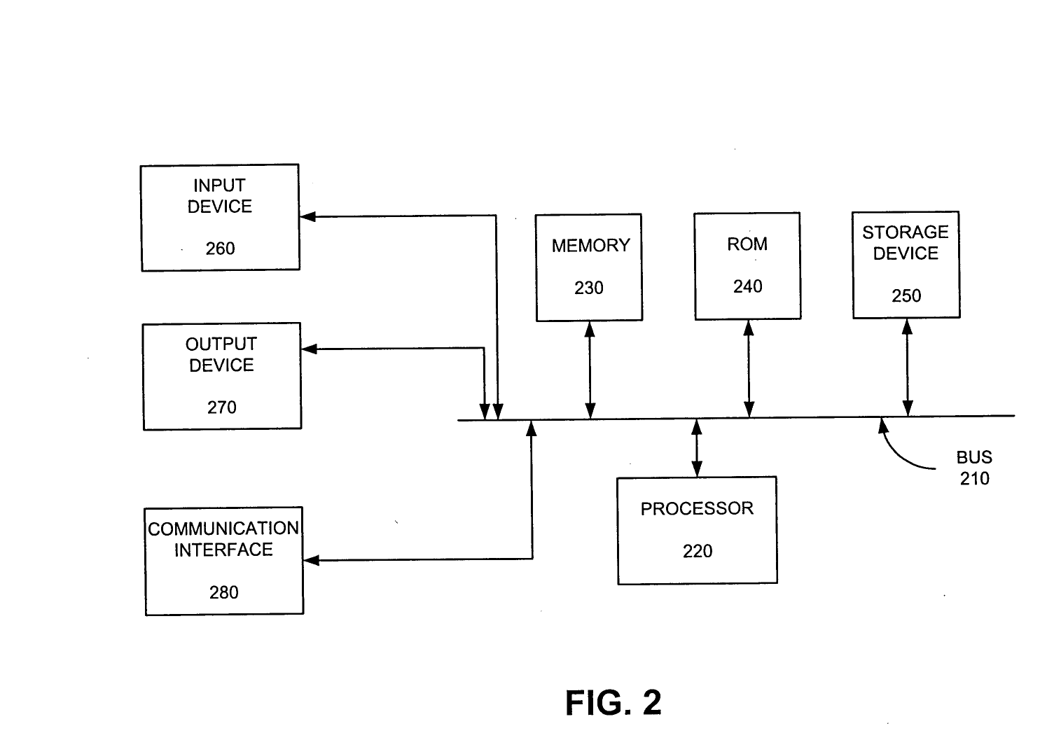

FIG. 2 is an exemplary diagram of server 120 in an implementation consistent with the principles of the invention. Server 140 may be configured in a similar manner. Server 120/140 may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of server 120/140.

Processor 220 may include any type of conventional processor or microprocessor that interprets and executes instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device 260 may include one or more conventional mechanisms that permit a user to input information to server 120/140, such as a keyboard, a mouse, a pen, voice recognition and/or biometric mechanisms, etc. Output device 270 may include one or more conventional mechanisms that output information to the user, such as a display, a printer, a speaker, etc. Communication interface 280 may include any transceiver-like mechanism that enables server 120/140 to communicate with other devices and/or systems. For example, communication interface 280 may include mechanisms for communicating with another device or system via a network, such as network 150.

Server 120, consistent with the principles of the invention, may perform searches based on inputs from clients 110. Server 140, consistent with the principles of the invention, may perform conversion tracking associated with clients 110 interacting with advertiser 130. Server 120/140 may perform these operations in response to processor 220 executing software instructions contained in a computer-readable medium, such as memory 230. A computer-readable medium may be defined as one or more memory devices and/or carrier waves.

The software instructions may be read into memory 230 from another computer-readable medium, such as data storage device 250, or from another device via communication interface 280. The software instructions contained in memory 230 causes processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

In addition, server 120 and server 140 are illustrated in FIG. 1 as being single devices. Server 120 and server 140 may each be implemented as a network of computer processors and/or servers.

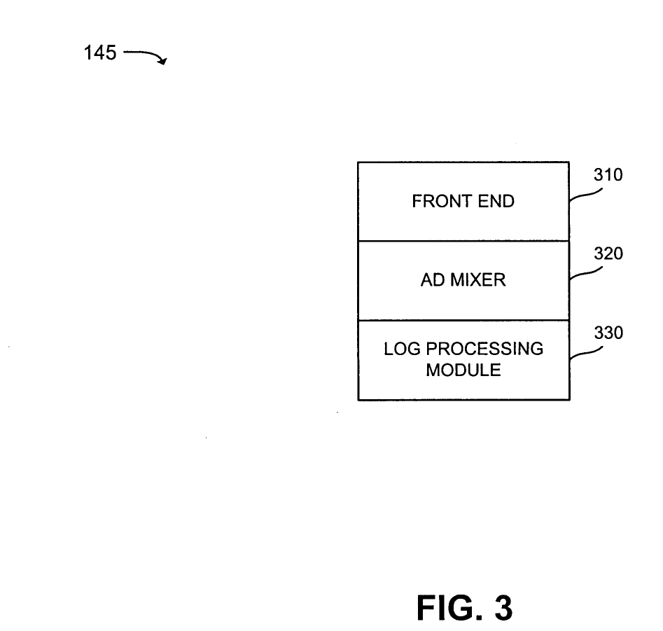

FIG. 3 is an exemplary functional block diagram of conversion tracker 145, according to an implementation consistent with the present invention. The logical blocks illustrated in FIG. 3 may be implemented in software, hardware, or a combination of hardware and software. In addition, each of the functional blocks may represent one or more computer processors, threads, and/or objects that track and process user actions and generate conversion related information.

Conversion tracker 145 may include a front end (FE) 310, an ad mixer 320 and a log processing module 330. FE 310 acts as the front end of conversion tracker 145 to receive information associated with conversion tracking, such as ad click information, and generate cookies, as described in more detail below. For example, FE 310 may set and parse hypertext transfer protocol (HTTP) cookies associated with tracking user actions. Ad mixer 320 may receive ad click information and return information regarding the ad click to FE 310. Log processing module 330 may analyze ad click and conversion information and generate reports based on this information. It should also be understood that in alternative implementations, the functions performed by one of the logical blocks in FIG. 3 may be performed by another logical block. Further, in alternative implementations, a single logical block/processing device may perform the functions of conversion tracker 145.

### Exemplary Processing

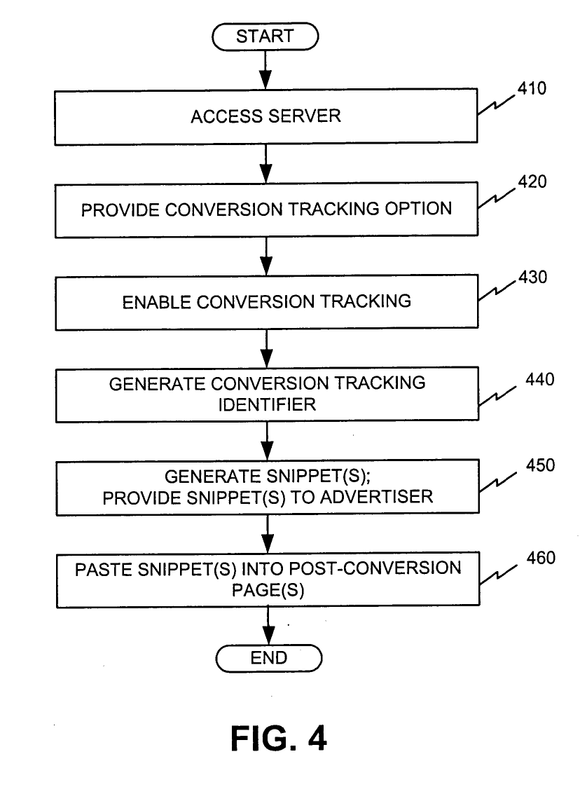

FIG. 4 is a flow diagram illustrating an exemplary process for enabling conversion tracking in an implementation consistent with the principles of the invention. The following description focuses on one or more servers that provide searching functions and paid advertisements. It will be appreciated that the techniques described herein are equally applicable to any server(s) that may provide advertisements for which fees are charged when the advertisements are selected by or presented to a user of a client device, such as client 110 in FIG. 1, and indeed to any system in which particular user actions are to be determined. For example, the techniques described herein are applicable to identifying user actions with respect to traditional banner advertisements, advertisements targeted based on the content or concepts in a document or page being provided to users, etc.

Processing may begin by an advertiser accessing server 120 (act 410). For example, advertiser 130 may connect to server 120 via network 150 by entering a uniform resource locator (URL) in a browser being executed by advertiser 130. Alternatively, an entity associated with advertiser 130 may connect to server 120 via a processing device/computer executing a conventional web browser. Server 120 may provide a user interface (UI) that includes a selection for advertisers that purchase advertising related to key words that may be input to the search engine executed by server 120. For example, as discussed above, advertiser 130 may represent an existing advertiser who has purchased one or more words/terms associated with computer queries/searches. Purchasing these words/terms may enable advertiser 130 to be featured when a search query entered by a user includes those words/terms. For example, advertiser 130 may be featured by an ad (whether in the form of a banner ad, text ad, pop-up or pop-under window, etc.) on a web page displayed to a client 110.

Assume that advertiser 130 clicks on (i.e., selects) the advertiser option. Server 120 may then provide a UI that includes a button/box that may be clicked or selected to enable conversion tracking for that advertiser (act 420). The conversion tracking option may allow an advertiser to individually enable conversion tracking for each account that the particular advertiser controls. For example, advertiser 130 may control multiple accounts. In this case, advertiser 130 may wish to enable conversion tracking for one or more of the accounts. Assume that advertiser 130 has a single account and enables conversion tracking for that account (act 430). When conversion tracking is enabled, server 140 will be able to track conversion rates with respect to ad clicks, ad impressions and other information, as described in more detail below. The term “ad impression” as used herein generally refers to the display of an advertisement to a client 110.

After conversion tracking is enabled, server 120 may generate a conversion tracking identifier (ID) associated with each account that has been selected for conversion tracking (act 440). The particular conversion tracking ID may be unique for each particular account. In the example above in which advertiser 130 enabled conversion tracking for a single account, server 120 may generate a single conversion tracking ID. In some implementations, the conversion tracking ID may correspond to advertiser 130's account ID. This conversion tracking ID enables server 120 to maintain privacy with respect to clients 110. For example, in implementations consistent with the principles of the invention, the conversion tracking ID is included in a cookie path associated with tracking ad clicks, as described in more detail below. This may limit the number of cookies being transmitted, thereby reducing privacy concerns associated with some users. In other implementations, a single conversion tracking ID may be used for all advertisers that have enabled conversion tracking or no conversion tracking ID may be used.

Note that the conversion tracking ID may not affect the level of granularity at which reports may be generated. For example, even if a single conversion tracking ID was used for all advertisers in the system, server 140 may still associate the ad click data with specific advertisers, campaigns, creatives, etc. This is because the cookies may include additional information regarding the ad clicks, such as advertiser specific information.

After conversion tracking is enabled and a conversion tracking ID has been assigned, server 120 generates a snippet, e.g., a piece of software code, that may be provided to advertiser 130 (act 450). In an exemplary implementation consistent with the present invention, the snippet may be a piece of hypertext markup language/JavaScript (HTML/JS) code that allows clients 110 and/or advertiser 130 to pass information to server 140, such as the value of a conversion and a label describing the type of conversion (e.g., a purchase, a registration, a page view, a download, etc.), after a conversion has occurred. In an exemplary implementation consistent with the present invention, the snippet may be an image request that is transmitted to server 140 after a conversion has occurred. An example of such an HTML snippet may be as follows:
<img src=“http://www.googleadservices.com/pagead/conversion/GHSnx87543x/conversion?
value=123&label=“Purchase”&format120x60>

In this example, “googleadservices.com” represents server 140 and GHSnx87543x represents the conversion tracking ID assigned to the conversion tracking enabled account associated with advertiser 130. The conversion tracking ID included in the snippet may be used to determine whether client 110 will send a cookie to server 140 after a conversion occurs, as described in more detail below. “Value” and “label” may represent optional parameters that can be dynamically generated and appended to the HTML image request. The value parameter may represent an advertiser defined unit or value associated with a conversion specified in any units (e.g., dollars). If a particular advertiser has the same unit or value for each conversion, server 120 may include the actual unit/value in the snippet. For example, if each conversion is worth $10 to advertiser 130, the value field may specify the value of ten dollars. The label parameter may be a free form text label that can be assigned to differentiate types of conversions that may be used in a final report (e.g., “purchase,” “registration,” “mailing list signup,” “page view,” “download,” etc.). The set of available labels may be predefined and any requests not included within the predefined list may be marked as an UnknownLabelType. The label parameter may also be set dynamically, per page, to advertiser specific custom labels. The format parameter defines the size of the post conversion page image that will be returned to advertiser 130 when a conversion is achieved, as described in more detail below.

Server 120 may also provide a JS wrapper and instructions to advertiser 130 that facilitate setting the value and label parameters and pasting the snippet into the appropriate page. For example, server 120 may provide a number of snippets that may be pasted into a number of advertiser pages. The JS wrapper may facilitate setting the values and labels in each snippet based on the particular item/product associated with the conversion. For example, if advertiser 130 sells only three products having prices of $50, $100 and $200, server 120 may provide three snippets and advertiser 130 may set the value in each snippet to the values $50, $100 and $200, respectively. Alternatively, server 120 may set the values in each snippet and also include the appropriate label for each snippet.

After server 120 provides advertiser 130 with the HTML/JS snippet(s), along with instructions associated with the snippet, advertiser 130 may paste the snippet(s) in the appropriate post conversion page(s) on advertiser 130's web site (act 460). As described previously, each advertiser may define what acts are considered conversions. When a client 110 performs such a predefined act, a conversion has taken place. For example, a purchase, a registration, a page view, a sign-up, a download, etc., may be considered a conversion. In each case, a post-conversion page provided by advertiser 130 may be displayed to client 110. For example, in the case of a purchase, advertiser 130 may provide a web page to client 110 after client 110 has transmitted a credit card number to advertiser 130 for purchasing a particular product. When advertiser 130 receives the credit card information, the purchase has been completed and advertiser 130 may provide a page that states “Your purchase has been completed. Your total charges are X.” Such a page may represent a post-conversion page.

After advertiser 130 pastes the HTML/JS snippet(s) into the appropriate post conversion page(s), conversion tracking is enabled for advertiser 130. The process for conversion tracking may then commence in a manner that is transparent with respect to advertiser 130.

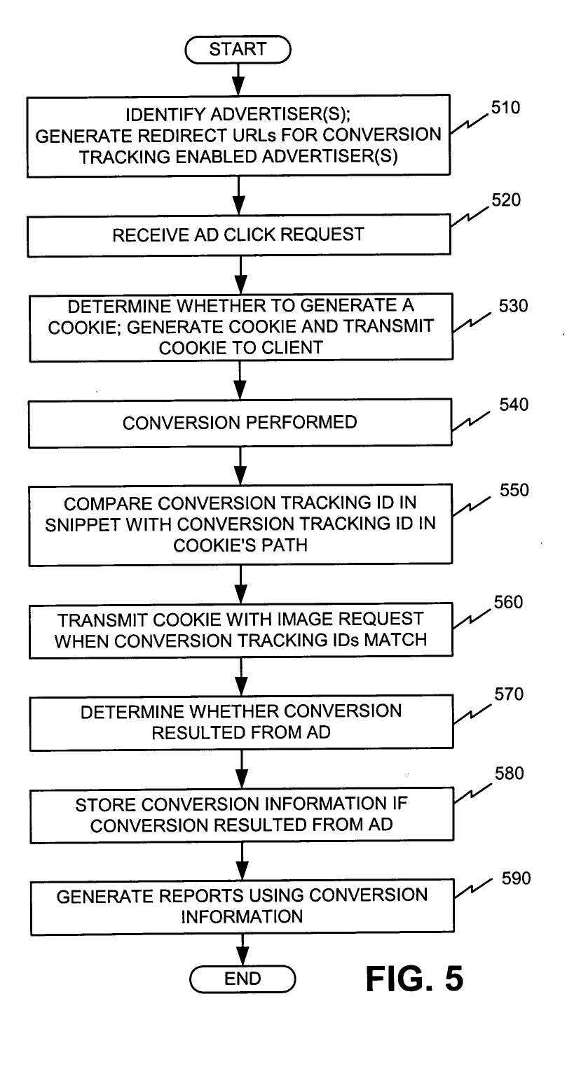

FIG. 5 illustrates exemplary processing associated with conversion tracking, consistent with the principles of the invention. The processing described below uses the example of conversion tracking associated with ads based on search queries. However, as discussed above, the techniques described herein may be used in any system in which particular user actions are to be determined/identified. Processing may begin with a client 110 accessing server 120 via network 150 and receiving a UI for entering a search query. Assume that the user enters a search query and transmits the search query to server 120. Server 120 receives the search query, executes the search and generates a list of search results.

Server 120 may also identify advertiser(s) based on the search query (act 510). For example, server 120 may store advertiser information in a memory, such as storage device 250 (FIG. 2). The advertiser information may include a database of key words and corresponding advertisers (along with their URLs) who have purchased advertising associated with the key words. When server 120 receives a query, server 120 searches the advertiser information to determine whether any advertiser has purchased advertising associated with one or more terms in the input query. Server 120 may then identify the advertiser(s) associated with the input query and the particular web site(s) associated with the respective advertiser(s). In one implementation, server 120 may also generate a redirect URL for each identified advertiser that has enabled conversion tracking so that the URL points to server 140 (act 510). For example, server 120 may generate a redirect URL associated with a conversion tracking enabled advertiser, such as:
http://www.googleadservices.com/pagead/adclick?
adurl=http://www.advertiser.com/landingpage&sa=1
   This redirect URL may point to googleadservices.com, which in this example, corresponds to server 140, and may indicate that the redirect is associated with an ad click on a page ad. The redirect URL may also point to the advertiser's landing page or home page (i.e., advertiser.com/landingpage). The presence of sa=1 in the exemplary URL above may be used by log processing module 330 to recognize this URL is associated with an ad click. Other information may also be included in the redirect URL.

After generating the redirect URL(s) for each conversion tracking enabled advertiser associated with the search query, server 120 transmits the search results and advertisement(s) to client 110 for display. Assume that a user, via client 110, performs an ad click on an ad associated with a conversion tracking enabled advertiser displayed on client 110. For example, assume that a web site associated with advertiser 130 is provided on the web page displayed on client 110 and that advertiser 130 has enabled conversion tracking. Further assume that the user, via client 110, clicks on the displayed ad associated with advertiser 130.

After client 110 selects the ad associated with advertiser 130, an ad click request is sent to server 140 as a result of the redirect URL generated at act 510 (act 520). For example, server 140 may receive an ad click HTTP request, such as:
http://www.googleadservices.com/pagead/adclick?
url=http://www.advertiser.com/landingpage&sa=1

As discussed above, the redirect URL points to googleadservices.com, which in this example, corresponds to server 140. Conversion tracker 145 in server 140 receives the ad click request and directs client 110 to advertiser's 130 home page or landing page, which in this example may be http://www.advertiser.com/landing page. In an exemplary implementation, FE 310 may also store or log the ad click request and forward the ad click request to ad mixer 320. In some implementations consistent with the present invention, FE 310 may also redirect the request back to itself by, for example, rewriting sa=l to sa=L. This may ensure that clicks by web crawlers are not counted in the number of ad clicks associated with an advertiser. For example, automated crawling software that does not follow HTTP redirects will never make a request for the URL where the field sa=l has been rewritten to sa=L. This prevents spamming by automated crawlers that lack this redirect following feature.

Ad mixer 320 receives the ad click request and may log the ad click request. Ad mixer 320 and/or FE 310, may also analyze the ad click request to determine whether a cookie should be generated in response to the ad click (act 530). For example, cookies may be set for conversion tracking enabled advertisers. In the example above, since conversion tracking is enabled for advertiser 130, ad mixer 320 and/or FE 310 may determine that a cookie should be set. Ad mixer 320 may also identify the conversion tracking ID associated with advertiser 130, which will be included in the cookie path. In an exemplary implementation consistent with present invention, including the conversion tracking ID in the cookie path limits the number of cookies that will be sent to server 140, as described in more detail below.

Ad mixer 320 may further identify the approximate time that the ad click occurred and generate an ad click time stamp (TS). The TS may be a globally unique identifier that includes the time that ad mixer 320 received the ad click request. The TS may also include other information, such as server IP address/host processor ID, etc., to ensure that the TS is globally unique. Ad mixer 320 may then generate a message including the TS, a conversion tracking ID and a Boolean indicating whether a cookie should be set. If the ad click was not associated with a conversion tracking enabled advertiser, the Boolean will indicate that no cookie should be generated. Ad mixer 320 may forward this message to FE 310.

FE 310 receives the message from ad mixer 320 and determines whether a cookie is to be set. The cookie may represent a conversion tracking cookie associated with tracking conversions for an advertiser. Assume that the information from ad mixer 320 indicates that a cookie is to be set, FE 310 may then generate the conversion tracking cookie (act 530). In an exemplary implementation, the conversion tracking cookie may also include a click string (CS). The CS may represent the particular ad click(s) or action(s) performed by the user and may be used to track the user's actions. The conversion tracking cookie may also include the ad click TS and/or an expiration date associated with the cookie. The conversion tracking cookie's path may also include the conversion tracking ID of the conversion tracking enabled advertiser. FE 310 may send the cookie to client 110 along with the redirect URL pointing to advertiser 130's site (act 530). For example, server 140 may send an HTTP message to client 110 that includes the following information:
Set-Cookie: CONVERSION=CS=A6yIzdSDw-4-iX8pj0IqkRPRxTzfA1Kp6FA5xKXgACApTBAsmMEABCgpF:TS=1055812564745609;
path=/pagead/conversion/GHSnx87543/; domain=.googleadservices.com; expires=Tue, 17 Jun. 2003 01:02:03 GMT

In the example above, the message indicates that a cookie identified as CONVERSION is to be set and that the cookie includes a CS. The message also includes a TS and an expiration date associated with the cookie. For example, the cookie may be set to expire 30 days from the time the cookie was created. This prevents old cookies from being used to incorrectly identify later conversions. Shorter or longer cookie expiration periods may also be used. In other implementations, the cookie may just include the TS identifying when the cookie was created. In this case, server 140 may determine whether the cookie has expired based on the TS. In still other implementations, the cookie may not include an expiration date. In further implementations, the cookie may be a session cookie that may expire when the client's 110 browser closes.

The exemplary message above also includes a path for the cookie and a domain. The domain, googleadservices.com, corresponds to server 140 in this example. The cookie path in the example above is: pagead/conversion/GHSnx87543/. The field GHSnx87543 in the cookie path may represent the conversion tracking ID for advertiser 130. By including the conversion tracking ID in the cookie path, this cookie will not be forwarded to server 140 when ad clicks associated with other advertisers are performed. For example, in one implementation consistent with the present invention, client 110 will only send a cookie associated with a particular advertiser when client 110 performs what that particular conversion tracking enabled advertiser pre-defined to be a conversion, as described in more detail below. When client 110 clicks on impressions or performs conversions not associated with advertisers that have not enabled conversion tracking, no cookies will be sent by client 110. Reducing the number of times cookies are sent reduces the ability of server 140 to track user actions. This may reduce privacy concerns of privacy sensitive users. In other implementations consistent with the present invention in which privacy concerns are not as great, client 110 may send cookies associated with conversion tracking enabled advertisers when no conversions for those advertisers have occurred. In this manner, server 140 may identify more actions performed by users.

Client 110 receives the message indicating that the cookie is to be set and redirect URL from server 140. Client 110 may store the cookie and use the redirect URL to access advertiser 130's web site. Thereafter, additional user actions (e.g., conversions) associated with advertiser 130 may be transmitted to server 140 via the cookie.

Assume that client 110 performs an act defined by advertiser 130 to be a conversion for that particular advertiser (act 540). In this case, when client 110 performs the conversion, advertiser 130 downloads a post conversion page to client 110. As discussed above with respect to FIG. 4, the post conversion page includes the snippet (i.e., the HTML image request) provided to advertiser 130. As further discussed above, in one implementation, the snippet may include an image request. Advertiser 130 downloads the post conversion page to client 110. When client 110 receives and displays the post conversion page, client 110 executes the snippet. The snippet, as described previously with respect to FIG. 4, may include a conversion tracking ID associated with advertiser 130. When the snippet is executed, client 110 sends the image request to server 140. That is, client 110 executes the snippet and sends a post conversion image request to server 140. For example, the post conversion HTTP image request may include the following information:
http://www.googleadservices.com/pagead/conversion/GHSnx87543x/?value=123&label=Purchase&format=120x60.
   This image request includes information indicating that a conversion occurred, the conversion tracking ID, a value, a label and a format for the image.

Client 110 may also compare the conversion tracking ID included in the snippet (GHSnx87543x in this example) with the conversion tracking ID in the stored cookie's path (act 550). That is, client 110 compares the conversion tracking ID included in the snippet on advertiser 130's post conversion page with the conversion tracking ID associated with the cookie received at act 530. When the conversion tracking IDs match, client 110 transmits the cookie, along with the post conversion image request, to server 140 (act 560). It should be understood that client 110 may receive a number of cookies from server 140 when client 110 performs ad clicks associated with various conversion tracking enabled advertisers in a manner similar to that discussed above with respect to advertiser 130. Therefore, client 110 may compare the conversion tracking ID in the post conversion snippet with the conversion tracking IDs included in the cookie path for each of the cookies stored on client 110. When the conversion tracking ID in the snippet matches any one of the conversion tracking IDs in a cookie path of a stored cookie, the client 110 will send that cookie to server 140. In some implementations consistent with the present invention, client 110 may also examine the TS, if a TS is included in the cookie, to determine whether to send the cookie to server 140. For example, if client 110 determines that the cookie has expired, client 110 may not send the cookie. Server 140, however, may also look at the TS, as described below.

Assuming that the conversion tracking ID in the snippet matches the cookie associated with advertiser 130 (and optionally, the TS indicates that the cookie has not expired), client 110 sends the cookie for advertiser 130 and the post conversion image request to server 140. When server 140 receives the image request, conversion tracker 145 examines the request and determines whether the conversion resulted from a paid advertisement (act 570). For example, server 140 may look to see whether the cookie with the unique conversion tracking ID associated with advertiser 130 has been received with the image request. The cookie may also include the CS as part of the cookie payload and the CS may identify the particular ad click(s) and/or action(s) performed by client 110. The cookie may also contain other data that may be used to correlate the click event with the conversion, e.g., when the click happened, the ad that was clicked on, etc.

If conversion tracker 145 does not find such a cookie included with the image request, FE 310 may determine that the conversion did not result from a paid advertisement. If FE 310 has received such a cookie with the image request, FE 310 may determine whether the cookie has expired based on the expiration date or TS information included with the cookie. Server 140 may store information associated with the conversion, such as the value, type, etc. (act 580). FE 310 may also return an image to client 110 that states, for example, “Thank you for shopping at a Google advertiser.” Client 110 may then paste this image into the post conversion page displayed on client 110. Providing this image in the post conversion page allows clients 110 to be aware that some of their actions are being tracked. If FE 310 determines that the conversion did not result from a paid ad or that the cookie associated with the paid ad had expired, server 140 may not store the conversion information. Server 140 may also return a blank image or no image and client 110 will not receive any additional message on the post conversion page.

FE 310 may also log the received image request into a log, such as a binary formatted log. FE 310 may further send a message to ad mixer 320 indicating that the conversion occurred. Ad mixer 320 may also log the conversion event in an ad conversion log. The ad conversion log may include records, such as, a number of conversion events, a value associated with each conversion event, a label associated with each conversion event, a time associated with each conversion event, the search engine or ad network associated with each conversion event, etc. Log processing module 330 may access the ad conversion log and use the ad conversion data to populate a conversion events database. Log processing module 330 may then generate reports based on information in the conversion events database (act 590).

For example, log processing module 330 may generate a conversion ratio for a particular advertiser, such as advertiser 130. The conversion ratio may be based on the number of times a displayed ad associated with an advertiser 130 was clicked at least once divided by the number of conversions that resulted from the ad. By generating the conversion ratio, both advertisers and search engine providers may determine the effectiveness of the paid ads.

More detailed analysis of advertisements can also be made. For example, log processing module 330 may determine a total value of all conversions over a period of time for a particular advertiser that resulted from ads, a value per click, etc. Log processing module 330 may also determine a conversion ratio based on where the ad is displayed. That is, server 140 may store information indicating whether the paid ad was displayed at the top of a web page, as opposed to another location, such as the side of the web page, or the position of the ad in a ranked list. Log processing module 330 may then analyze a conversion ratio with respect to the location of the displayed ad.

### Conclusion

Implementations consistent with the principles of the invention detect particular user actions to provide conversion tracking with respect to paid advertisements. One advantage this provides is that conversions can be tracked while the amount of information collected with respect to user actions is minimized. This is accomplished by setting the path of each cookie to specific paths/domains associated with an individual advertiser. That is, by including advertiser specific elements in the cookie path, the tracking of user actions is limited. Therefore, clicking on a number of ads on sites not associated with a conversion tracking enabled advertiser will not result in the transmission of cookies. In addition, by setting cookies on ad clicks, instead of ad impressions this further limits the number of cookies being sent. This reduces privacy concerns for privacy sensitive users.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while series of acts have been described with regard to FIGS. 4 and 5, the order of the acts may be varied in other implementations consistent with the present invention. Moreover, non-dependent acts may be implemented in parallel.

Also, implementations consistent with principles of the invention have been described with respect to setting cookies on advertiser specific paths when an ad click is received. In other implementations, a cookie could be set on an ad impression. In this manner, a “view through” conversion may be captured. A view through conversion may be defined as a conversion that occurred just by viewing the ad impression. Browsers, however, often limit the number of cookies that may be stored. To overcome this potential problem, a single cookie may be set to be associated with all the ad impressions.

In further implementations, a single cookie could be used for multiple advertisers. Such a cookie could then be used to track ad clicks associated with any one of the multiple advertisers. Conversion tracker 145 could then determine which ad clicks were associated with which particular advertiser based on information transmitted with the cookie. In this manner, conversion tracker 145 would be able to determine a conversion ratio for each advertiser.

Lastly, implementations consistent with principles of the invention have been described as receiving an image request when a conversion occurred. The image request has been described as being transmitted by a client device when it receives a particular web page from an advertiser. In alternative implementations, the advertiser may transmit information to a server, such as server 140, indicating that a conversion occurred. The conversion information may include optional value and label parameters. In this case, server 140 may not need to generate cookies to track the user's actions. That is, server 140 may store an indication that an ad click for a paid advertiser was received at a certain time. When server 140 receives a conversion indication from a particular advertiser, server 140 may correlate that conversion information to the stored ad click information to determine whether the conversion resulted from an ad. Further, in other implementations of the present invention, other types of requests (other than image requests) or no image request may be received with a conversion indication. In each case, server 140 may return (or not return) the appropriate information. Conversion tracker 145, however, still receives information indicating that a conversion occurred.

No element, act, or instruction used in the description of the present application should be construed as critical or essential to the invention unless explicitly described as such. Also, as used herein, the article “a” is intended to include one or more items. Where only one item is intended, the term “one” or similar language is used.

1. A method for tracking user actions, comprising:
identifying a user action;
generating a cookie in response to the user action, the cookie being associated with an advertiser;
transmitting the cookie to the user; and
receiving the cookie from the user in response to an other action by the user.

2. The method of claim 1, further comprising:
identifying a conversion based at least in part on the receipt of the cookie, the conversion corresponding to at least one of a purchase, a registration, a sign-up, a page view and a download.

3. The method of claim 2, further comprising:
receiving information in response to the other action by the user, and wherein the identifying a conversion further comprises:
identifying the conversion based on receipt of the information and receipt of the cookie.

4. The method of claim 3, wherein the information comprises an image request, the method further comprising:
providing an image in response to the image request.

5. The method of claim 1, wherein the user action corresponds to a selection of an advertisement associated with the advertiser and the other action corresponds to a conversion associated with the advertiser.

6. The method of claim 1, wherein the generating a cookie comprises:
including an identifier associated with the advertiser in the cookie's path

7. The method of claim 6, further comprising:
comparing, at the user's device, the identifier associated with the advertiser in the cookie's path to an identifier included on a post conversion page of the advertiser; and
transmitting, by the user's device, the cookie when the identifiers match.

8. The method of claim 1, further comprising:
providing'software to the advertiser, the software configured to be:
appended to at least one web page of the advertiser, and
executed when the at least one web page is retrieved.

9. The method of claim 8, further comprising:
receiving information when the software appended to the at least one web page is executed.

10. The method of claim 9, further comprising:
determining that a conversion resulted from an advertisement based on whether the cookie was received and the received information.

11. The method of claim 9, wherein the received information comprises at least one of a value and an activity type.

12. The method of claim 1, wherein the other action corresponds to at least one of a purchase activity, a registration activity, a page view activity and a download activity, the method further comprising:
identifying a conversion; and
determining whether the conversion resulted from an advertisement associated with the advertiser based on receipt of the cookie.

13. The method of claim 1, further comprising:
including at least one of an expiration date and a time stamp with the cookie; and
determining whether a conversion resulted from an advertisement associated with the advertiser based at least in part on whether the cookie received from the user has expired.

14. The method of claim 1, further comprising:
receiving a request for conversion tracking by the advertiser; and
providing software to be included on the advertiser's web site.

15. The method of claim 14, wherein the software includes at least one of a value field and a label field associated with a conversion and the value field and label field may be set by the advertiser.

16. The method of claim 1, further comprising:
generating a unique identifier for the advertiser, wherein the unique identifier is included with the cookie.

17. The method of claim 1, further comprising:
generating a conversion ratio for the advertiser based at least in part on a number of conversions associated with the advertiser, each conversion being associated with at least one of a purchase activity, a registration activity, a sign-up activity, a page view activity and a download activity.

18. The method of claim 17, wherein the generating a conversion ratio includes:
determining a number of times an advertisement associated with the advertiser has been displayed or selected,
determining a number of conversions resulting from the displayed advertisement, and
generating a conversion ratio based on the number of times the advertisement was displayed or selected and the number of conversions.

19. A system for detecting user actions, comprising:
means for generating a cookie in response to a user action associated with an advertisement provided to the user; and
means for determining that a conversion resulted from the advertisement.

20. The system of claim 19, further comprising:
means for receiving the cookie in response to an other user action; and
means for receiving information in response to the other user action, wherein the means for determining determines that a conversion resulted from the advertisement based on receipt of the cookie and the received information.

21. A computer-readable medium that stores instructions executable by at least one processor to perform a method for tracking user actions, the computer-readable medium comprising:
instructions for generating a cookie in response to a first user action, the cookie being associated with an advertiser;
instructions for receiving the cookie from the user in response to a second action by the user; and
instructions for determining whether a conversion resulted from the advertisement based at least in part on receipt of the cookie.

22. A server comprising:
a memory; and
a processor configured to:
receive at least one cookie in response to a user action, the cookie being associated with an advertiser,
store the at least one cookie in the memory,
receive a conversion indication associated with the advertiser, and
determine whether the conversion resulted from an advertisement associated with the advertiser based at least in part on the stored cookie.

23. The server of claim 22, wherein the processor is further configured to:
receive a plurality of cookies associated with the advertiser,
receive a plurality of conversion indications associated with the advertiser, and
determine a conversion ratio associated with the advertiser based at least in part on the plurality of cookies and the plurality of conversion indications.

24. A method for enabling tracking of users' actions, comprising:
providing a conversion tracking option to an advertiser;
receiving a selection from the advertiser, the selection indicating that the advertiser wishes to enable tracking of users' actions for at least one account associated with the advertiser; and
enabling tracking for the at least one account.

25. The method of claim 24, further comprising:
generating an identifier associated with the at least one account, wherein the identifier is inserted in a cookie path associated with tracking users' actions with respect to the advertiser.

26. A method for tracking user actions, comprising:
providing an ad to a user;
receiving an ad click associated with the ad;
generating a cookie in response to the ad click;
transmitting the cookie to the user;
receiving information in response to a user action, the information indicating that the user performed a conversion associated with an advertiser; and
determining whether the conversion resulted from the ad.

27. The method of claim 26, wherein the generating a cookie comprises:
including an identifier associated with the advertiser in the cookie's path.

28. The method of claim 27, further comprising:
receiving the cookie in response to the user action, and wherein the determining comprises:
determining whether the conversion resulted from the ad based at least in part on receipt of the cookie.

29. The method of claim 26, further comprising:
receiving a plurality of cookies in response to ad clicks associated with the advertiser;
receiving a plurality of conversion indications associated with the advertiser; and
determining a conversion ratio based at least in part on the plurality of received cookies and the plurality of received conversion indications.

30. The method of claim 26, further comprising:
receiving the cookie from the user when the user performs the conversion.

31. The method of claim 30, further comprising;
preventing the cookie from being transmitted by the user when a conversion not associated with the advertiser is performed.

32. The method of claim 30, further comprising:
preventing the cookie from being transmitted by the user when a conversion not associated with any advertiser is performed.

33. The method of claim 26, further comprising:
receiving the cookie from the user only when the user performs a conversion associated with the advertiser.

34. A method, comprising:
selecting an ad associated with an advertiser;
receiving a cookie in response to the selection;
performing a conversion associated with the advertiser;
determining whether an identifier associated with the cookie matches an identifier on a web page associated with the conversion; and
transmitting the cookie when the identifiers match.
